(19) United States
(12) Patent Application Publication
(10) Pub. No.: US 2016/0296909 A1
(43) Pub. Date: Oct. 13, 2016

(54) HYDROGEN PRODUCTION FROM WATER USING PHOTOCATALYSTS COMPRISING METAL OXIDES AND GRAPHENE NANOPARTICLES

(71) Applicant: SABIC GLOBAL TECHNOLOGIES B.V., Amsterdam (NL)

(72) Inventors: Moussa Saleh, Thuwal (SA); Ahmed Khaja Wahab, Thuwal (SA); Hicham Idriss, Thuwal (SA); Sandro Gambarotta, Ottawa (CA)

(21) Appl. No.: 15/036,502

(22) PCT Filed: Dec. 3, 2014
(86) PCT No.: PCT/IB2014/066567

§ 371 Date: May 13, 2016

Related U.S. Application Data
(60) Provisional application No. 61/911,805, filed on Dec. 4, 2013.

(51) Int. Cl. B01J 23/10; B01J 23/02; B01J 21/18; C01B 13/02; B01J 7/02; B01J 19/12; C01B 3/04; B01J 35/00; B01J 35/08

(52) U.S. Cl. CPC B01J 23/10; B01J 35/004; B01J 23/02; B01J 21/18; B01J 35/08; B01J 7/02; B01J 19/123; C01B 3/042; C01B 13/0207; B01J 2219/1203

(57) ABSTRACT

Disclosed is a photocatalyst, and methods for its use, that includes graphene nanostructures attached to the surface of a photoactive metal oxide semiconductor selected from SrTiO₃ or CeO₂, wherein the photoactive metal oxide semiconductor is a microstructure or larger.

### CROSS REFERENCE TO RELATED APPLICATIONS

This application claims the benefit of U.S. Provisional Application No. 61/911,805, filed Dec. 4, 2013. The contents of the referenced patent application are incorporated into the present application by reference.

### BACKGROUND OF THE INVENTION

A. Field of the Invention

The invention generally concerns photocatalysts that can be used to produce hydrogen from water in a photocatalytic reaction. The photocatalysts include SrTiO₃ or CeO₂ as the photoactive material and graphene (e.g., graphene oxide or reduced graphene oxide) as the conductive material.

B. Description of Related Art

Hydrogen production from water offers enormous potential benefits for the energy sector, the environment, and the chemical industry (See, for example, Kodama et al. Chem Rev. 2007, 107:4048; Connelly et al., in Green Chemistry. 2012, 14:260; Fujishima et al. in Nature, 1972, 238, 1972; Kudo et al. in Chem Soc Rev 38:253, 2009; Nadeem et al. in Nanotechnology 2012, 9:121; and Maeda et al. in Nature, 2006, 440:295). While methods currently exist for producing hydrogen from water, many of these methods can be costly, inefficient, or unstable. For instance, photo electrochemical (PEC) water splitting requires an external bias or voltage and a costly electrode (e.g., Pt-based) for electrolysis of water.

With respect to photocatalytic electrolysis of water from light sources, while many advances have been achieved in this area (See, for example, Connelly et al., in Green Chemistry. 2012, 14:260; Fujishima et al. in Nature, 1972, 238, 1972; Kudo et al. in Chem Soc Rev 38:253, 2009; Nadeem et al. in Nanotechnology 2012, 9:121; and Maeda et al. in Nature, 2006, 440:295), most materials are either unstable under realistic water splitting conditions or require considerable amounts of other components (e.g., large amounts of sacrificial hole or electron scavengers) to work, thereby offsetting any gained benefits. By way of example, a semiconductor photocatalyst is a material that can be excited upon receiving energy equal to or higher than its electronic band gap. Upon photo-excitation, electrons are transferred from the valence band (VB) to the conduction band (CB), resulting in the formation of an electron (in the CB) and a hole (in the VB). In the case of water splitting, electrons in the CB reduce hydrogen ions to H₂ and holes in the VB oxidize oxygen ions to O₂. One of the main limitations of most photocatalysts is the fast electron-hole recombination; a process that occurs at the nanosecond scale, while the oxidation-reduction reactions are much slower (microsecond time scale). Over 90% of photo-excited electron-hole pairs disappear before reaction by radiative and non-radiative decay mechanisms (See, for example, Yamada et al. in Appl Phys Lett., 2009, 95:121112-121112-3). Current photocatalysts such as those that utilize noble metals dispersed on the surface of a photoactive material suffer from these inefficiencies.

### SUMMARY OF THE INVENTION

A solution to the aforementioned inefficiencies surrounding current water-splitting photocatalysts has been discovered. In particular, the solution resides in using graphene nanostructures as the conductive material and either SrTiO₃ or CeO₂ microstructures or larger as the photoactive material. In one particular aspect, a relatively strong attachment of the graphene to the photoactive material is obtained by precipitation of an aqueous solution of the photoactive material in the presence of graphene. Without wishing to be bound by theory, it is believed that the specific combination of graphene nanostructures and SrTiO₃ or CeO₂ microstructures or larger reduce the likelihood that an excited electron would spontaneously revert back to its non-excited state (i.e., the electron-hole recombination rate can be reduced or suppressed). This provides for a more efficient use of the excited electrons in water-splitting applications. Further, this improved efficiency allows for a reduced reliance on additional materials such as sacrificial agents as well as electrically conductive noble metals, thereby decreasing the complexity and costs associated with photocatalytic water-splitting systems.

In one aspect of the present invention, there is disclosed a photocatalyst comprising graphene (e.g., graphene oxide or reduced graphene oxide or a combination thereof) nanostructures or combinations thereof attached to the surface of a photoactive metal oxide semiconductor selected from SrTiO₃ or CeO₂, wherein the photoactive metal oxide semiconductor is a microstructure or larger. Conductive material “attached” to the surface of a photoactive metal oxide semiconductor includes embodiments wherein the conductive material is chemically or physically bonded to the surface, and embodiments wherein the conductive material is dispersed or distributed on the surface of a photoactive metal oxide. In a preferred embodiment, the graphene is attached to the surface of the photoactive metal oxide semiconductor via precipitation of the photoactive metal oxide semiconductor from an aqueous solution comprising the graphene. In certain aspects, the nanostructure has a size ranging from 1 to less than 1000 nm, or 1 to 500 nm, or 1 to 100 nm, or 1 to 50 nm, or 1 to 25 nm, or 1 to 10 nm. In particular instances, the graphene is a nanowire, nanoparticle, nanocluster, or nanocrystal, or any combination thereof In even more particular instances, the graphene is not a graphene platelet or a graphene sheet (i.e., a sheet of carbon atoms arranged in a honeycomb lattice that has two opposing planar/substantially planar surfaces). The photoactive metal oxide semiconductor can be a particle such as a microparticle or larger. In particular embodiments, it was found that low amounts of conductive materials can be used and still efficiently split water and create hydrogen gas. Such amounts can be less than 5, 4, 3, 2, or 1 wt. % of the total weight of the photocatalysts. Also, the conductive material can cover less than 50, 40, 30, 20, 10, or 5% of the surface area of the photoactive metal oxide semiconductor, or can cover from about 0.0001 to 5% of the total surface area of the photoactive material, and still efficiently produce hydrogen from water. In particular aspects, the photocatalyst can be in particulate or powdered form and can be added to water. With a light source, the water can be split and hydrogen and oxygen gas formation can occur. In particular instances, a sacrificial agent can also be added to the water so as to further prevent electron/hole recombination. Notably, the efficiency of the photocatalyst of the present invention allows for one to avoid using or to use substantially low amounts of sacrificial agent when compared to known systems. In one instance, 0.1 to 5 vol. % of the photocatalyst and/or 0.1 to 5 g/L % of the sacrificial agent can be added to water. Non-limiting examples of sacrificial agents that can be used include methanol, ethanol, ethylene glycol propanol, iso-propanol, n-butanol, iso-butanol, ethylene glycol, propylene glycol, glycerol, or oxalic acid, or any combination thereof In particular aspects, ethanol is used or ethylene glycol is used or a combination thereof. The photocatalyst can be self-supported (i.e., it is not supported by a substrate) or it can be supported by a substrate (e.g., glass, polymer beads, metal oxides, etc.). As noted above, the photocatalysts of the present invention are capable of splitting water in combination with a light source. No external bias or voltage is needed to efficiently split said water. In one non-limiting embodiment, the photocatalyst is capable of producing hydrogen gas from water at a rate of 1×10⁻⁷ to 30×10⁻⁷ mol/g_{Catal} min. or from about 1×10⁻⁷ and 10×10⁻⁷ mol/g_{Catal} min, or from about 1×10⁻⁷ and 5×10⁻⁷ mol/g_{Catal} min, or from about 2×10⁻⁷ and 3×10⁻⁷ mol/g_{Catal} min.

Also disclosed is a system for producing hydrogen gas and/or oxygen gas from water. The system can include a container (e.g., transparent or translucent containers or opaque containers such as those that can magnify light (e.g., opaque container having a pinhole(s)) and a composition that includes photocatalyst of the present invention, water, and optionally a sacrificial agent. The container in particular embodiments is transparent or translucent. The system can also include a light source for irradiating the composition. The light source can be natural sunlight or can be from a non-natural source such as a UV lamp. As noted above, the system does not have to include an external bias or voltage.

In another embodiment, there is disclosed a method for producing hydrogen gas and/or oxygen gas from water, the method comprising using the aforementioned system and subjecting the composition to the light source for a sufficient period of time to produce hydrogen gas and/or oxygen gas from the water. The photocatalyst can be heated to between 200° C. and 400° C. prior to addition of the photocatalyst to the water. The hydrogen gas and/or oxygen gas can then be captured and used in other down-stream processes such as for ammonia synthesis (from N₂ and H₂), for methanol synthesis (from CO and H₂), for light olefins synthesis (from CO and H₂), or other chemical production processes that utilize H₂ etc. In one non-limiting aspect, the method can be practiced such that the hydrogen production rate from water can be modified as desired by increasing or decreasing the amount of light or light flux that the system is subjected to. By way of example, a light source having a flux of about 0.1 mW/cm² to 30 mW/cm² can be used to produce hydrogen at a rate of about 1×10⁻⁷ to 30×10⁻⁷ mol/g_{Catal} min.

The following includes definitions of various terms and phrases used throughout this specification.

“Water splitting” or any variation of this phrase describes the chemical reaction in which water is separated into oxygen and hydrogen.

“Inhibiting,” “preventing,” or “reducing” or any variation of these terms, when used in the claims or the specification includes any measurable decrease or complete inhibition to achieve a desired result. By way of example, reducing the recombination of an excited electron encompasses a situation where a decrease in the amount of recombination occurs in the presence of a photocatalyst of the present invention when compared with a situation where, for example, a photocatalyst is used that does not have the graphene nanostructure attached to the surface of a metal oxide semiconductor.

“Effective” or any variation of this term, when used in the claims or specification, means adequate to accomplish a desired, expected, or intended result.

“Nanostructure” refers to an object or material in which at least one dimension of the object or material is equal to or less than 100 nm (e.g., one dimension is 1 to 100 nm in size). In a particular aspect, the nanostructure includes at least two dimensions that are equal to or less than 100 nm (e.g., a first dimension is 1 to 100 nm in size and a second dimension is 1 to 100 nm in size). In another aspect, the nanostructure includes three dimensions that are equal to or less than 100 nm (e.g., a first dimension is 1 to 100 nm in size, a second dimension is 1 to 100 nm in size, and a third dimension is 1 to 100 nm in size). The shape of the nanostructure can be of a wire, a particle, a sphere, a rod, a tetrapod, a hyper-branched structure, or mixtures thereof. In some aspects, the nanostructure of the present invention can be a graphene platelet or a graphene sheet (i.e., a sheet of carbon atoms arranged in a honeycomb lattice that has two opposing planar/substantially planar surfaces), while in other instances it can exclude such graphene platelets or sheets.

“Microstructure” refers to an object or material in which at least one dimension of the object or material is between 0.1 and 100 μm and in which no dimension of the object or material is 0.1 μm or smaller. In a particular aspect, the microstructure includes two dimensions that are between 0.1 and 100 μm (e.g., a first dimension is 0.1 to 100 μm in size and a second dimension is 0.1 to 100 μm in size). In another aspect, the microstructure includes three dimensions that are between 0.1 and 100 μm (e.g., a first dimension is 0.1 to 100 μm in size, a second dimension is 0.1 to 100 μm in size, and a third dimension is 0.1 to 100 μm in size).

The terms “about” or “approximately” are defined as being close to as understood by one of ordinary skill in the art, and in one non-limiting embodiment the terms are defined to be within 10%, preferably within 5%, more preferably within 1%, and most preferably within 0.5%.

The use of the word “a” or “an” when used in conjunction with the term “comprising” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The photocatalysts and photoactive materials of the present invention can “comprise,” “consist essentially of,” or “consist of” particular components, compositions, ingredients, etc. disclosed throughout the specification. With respect to the transitional phase “consisting essentially of,” in one non-limiting aspect, a basic and novel characteristic of the photoactive catalysts and materials of the present invention are their ability to efficiently use excited electrons in water-splitting applications to produce hydrogen.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description.

### BRIEF DESCRIPTION OF THE DRAWINGS

FIG. 1 depicts a schematic diagram of a water splitting system of the present invention.

FIG. 2 is the valence band structure of reduced graphene oxide using N₂H₄. Distinct σ and π bands of graphene are clearly visible after Ar ion sputtering (1000 s, 3000 s, and 5000 s spectra).

FIG. 3 is a graph of time versus mol/g_{Catal} min for hydrogen production from water over graphene (G)/SrTiO₃ and graphene (G)/CeO₂ photocatalysts under UV photon excitation. The rates for hydrogen production were computed to be 3×10⁻⁷ mol/g_{Catal} min and 2×10⁻⁷ mol/g_{Catal} min for graphene/SrTiO₃ and graphene/CeO₂, respectively.

### DETAILED DESCRIPTION OF THE INVENTION

While hydrogen-based energy has been proposed by many as a solution to the current problems associated with carbon-based energy (e.g., limited amounts and fossil fuel emissions), the currently available technologies are expensive, inefficient, or unstable. The present application provides a solution to these issues. The solution is predicated on the use of photocatalysts that employ a photoactive metal oxide semiconductor selected from SrTiO₃ or CeO₂ in combination with a graphene nanostructure attached to the surface of said photoactive metal oxide. These photocatalysts can be used for efficient hydrogen production by splitting water via a light source such as sunlight or a UV lamp.

These and other non-limiting aspects of the present invention are discussed in further detail in the following sections.

### A. Photocatalysts

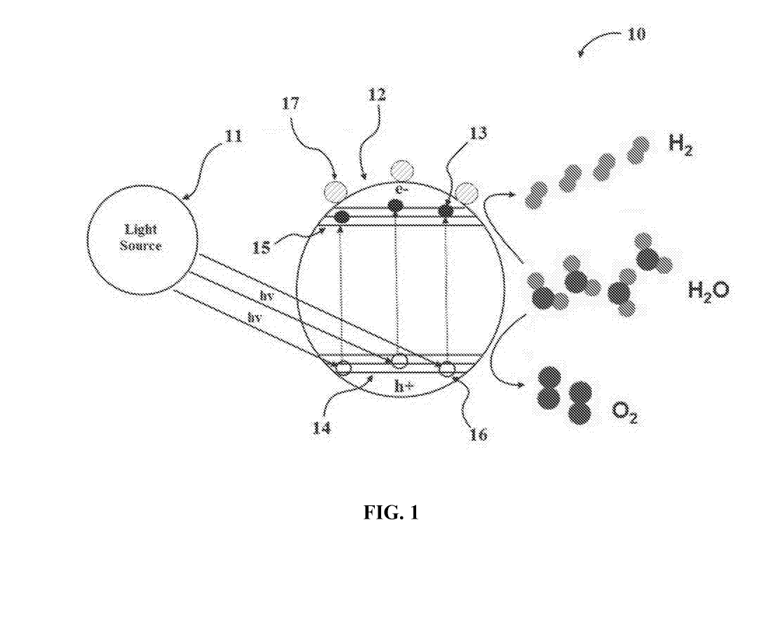

FIG. 1 shows a representation of a non-limiting embodiment of a photocatalyst system 10 of the present invention. The photocatalyst includes a photoactive metal oxide 12 and graphene 17 attached to at least a portion of the surface of the photoactive metal oxide 12. The photoactive metal oxide 12 can be strontium titanate (SrTiO₃), which is a semiconductor with a band gap of around 3.2 eV or cerium (IV) oxide (CeO₂), which is a semiconductor with a band gap of around 3.48 eV. SrTiO₃ and CeO₂ are capable, in combination with the graphene nanostructures 17 of the present invention, of catalyzing water splitting under UV light irradiation. In the embodiment shown, the photoactive metal oxide 12 has a generally circular cross-section. The photoactive metal oxide 12 can additionally be of any shape compatible with function in the photocatalyst 10 of the present invention, including but not limited to spherical, rod-shaped, irregularly shaped, or combinations thereof. The photoactive metal oxide 12 can also be, as non-limiting examples, a bulk material, a particulate material, or a flat sheet. The photoactive metal oxides 12 can be of any microstructure or larger size suitable for use in the photocatalyst system 10. In some embodiments, the photoactive metal oxides 12 are microstructures, meaning that they have at least one dimension measuring between 0.1 and 100 μm and no dimensions measuring 0.1 μm or less.

The graphene nanostructures 17 can be used as conductive material for the excited electrons to ultimately reduce hydrogen ions to produce hydrogen gas. The graphene can be graphene oxide or it can be graphene oxide that has been reduced. Graphene nanostructures 17 are conductive materials with very low resistivity, making them well suited to act in combination with a photoactive metal oxide 12 in photoactive catalyst of the present invention (e.g., 10) to facilitate fast transfer of excited electrons to hydrogen before the electron-hole recombination. The graphene 17 nanostructures have at least one dimension that measures 100 nm or less. In some embodiments, the nanostructures can have two or three dimensions that measure 100 nm or less. In some embodiments, the nanostructures can have one or two dimensions that measure more than 100 nm. The nanostructures can be of any shape suitable for use in the photoactive catalytic systems of the present invention, including but not limited to nanowires, nanoparticles, nanoclusters, nanocrystals, or combinations thereof.

### B. Methods of Making the Photocatalysts

The photoactive metal oxides 12 of the present invention are commercially available from a wide range of sources (e.g., Sigma-Aldrich® Co. LLC (St. Louis, Mo., USA); Alfa Aesar GmbH & Co KG, A Johnson Matthey Company (Germany)). Alternatively, they can be made by any process known by those of ordinary skill in the art (e.g., precipitation/co-precipitation, sol-gel, template/surface derivatized metal oxide synthesis, solid-state synthesis of mixed metal oxides, microemulsion technique, solvothermal, sonochemical, combustion synthesis, etc.). In a non-limiting aspect, the metal oxides 12 can be made by creating aqueous solutions of metal ions and precipitating metal oxides out of solution. This precipitation can take place in the presence of graphene 17, resulting in the nanostructures 17 being attached to at least a portion of the surface of the photoactive metal oxides 12.

Graphene nanostructures 17 are commercially available from a wide range of sources (e.g., Sigma-Aldrich® Co. LLC (St. Louis, Mo., USA); Graphenea S. A. (Donostia-San Sebastian, Spain)). Alternatively, they can be made by any process known by those of ordinary skill in the art (e.g., mechanical exfoliation, chemical vapor deposition, sonication, cutting open carbon nanotubes, reduction of graphite oxide, etc.). In a non-limiting aspect, graphene oxide 17 can be produced from graphite by oxidizing graphite to form graphite oxide, followed by stirring, sonication, or both to exfoliate graphene oxide monolayers from multi-layer graphite oxide. Graphene oxide 17 can then be reduced using a number of methods, including but not limited to exposure to hydrogen plasma, thermal treatment under hydrogen, exposure to strong pulse light, heating in distilled water, mixing with an expansion-reduction reagent such as urea followed by heating, directly heating in a furnace, linear sweep voltammetry, and exposure to a reducing agent such as, for example, N₂H₄.

Attachment of graphene nanostructures 17 to the surface of photoactive metal oxides 12 can be accomplished by any process known by those of ordinary skill in the art. Attachment can include dispersion and/or distribution of the nanostructures 17 on the surface of the photoactive metal oxides 12. Attachment can be accomplished, for example, by precipitating metal oxides 12 out of solution in the presence of graphene nanostructures 17, followed by drying and calcination. As another non-limiting example, metal oxide 12 and graphene 17 can be mixed in a volatile solvent. After stirring and sonication, the solvent can be evaporated off. The dry material can then be ground into a fine powder and calcined. Calcination (such as at 300° C.) can be used to further crystalize the metal oxides 12.

### C. Uses of the Photocatalysts

Once the photocatalysts of the present invention are prepared, they can be placed in a transparent container containing an aqueous solution and used in a water splitting system. Referring again to FIG. 1, the photocatalyst system 10 can be used to split water to produce H₂ and O₂. A light source 11 (e.g., natural sunlight or UV lamp) contacts the photoactive metal oxide 12, thereby exciting electrons 13 from their valence band 14 to their conductive band 15, thereby leaving a corresponding hole 16. The excited electrons 13 are used to reduce hydrogen ions to form hydrogen gas, and the holes 16 are used to oxidize oxygen ions to oxygen gas. The hydrogen gas and the oxygen gas can then be collected and used in down-stream processes. Due to the highly conductive graphene nanostructures 17 dispersed on the surface of the photoactive metal oxide 12, excited electrons 13 are more likely to be used to split water before recombining with a hole 16 than would otherwise be the case.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Materials and Methods Used to Prepare, Test, and Characterize Photocatalysts

### Synthesis of Reduced Graphene Oxide:

Graphene oxide (GO) was produced from graphite using a modified Hummers method (Hummers & Offeman, 1958). In a dry 500 mL round bottom flask equipped with a magnetic stirrer, graphite powder (1 g), sodium nitrate (1 g, 11.76 mmol), and sulphuric acid (46 mL) were combined and stirred in an ice bath. To the resulting reaction mixture, KMnO₄ (6 g, 37.96 mmol) was slowly added. Once mixed, the reaction flask was transferred to an oil bath and vigorously stirred for 1 h at 40° C. To the resulting brown paste, 80 ml of water was added, and the slurry was stirred for additional 1 h while the temperature was raised to 90° C. Finally, 200 mL of water was added, followed by the slow addition of 6 mL of H₂O₂ (30%), turning the color of the solution from dark brown to brownish-yellow. The product was filtered off (while warm), washed with excess water, and dried under reduced pressure.

Reduced GO (RGO) was made by placing into a 250 mL round bottom flask a suspension of the GO (0.3 g) in water (100 mL), followed by the addition of hydrazine monohydrate (0.1 mL). The mixture was then stirred for 24 h at 80° C. The resulting black powder was filtered off, sequentially washed with water, HCl (10%), and acetone. The product was finally dried under vacuum.

RGO was also made by placing a dry sample (0.1 g) of GO in a quartz tube furnace. The tube containing the GO sample was purged with nitrogen gas for 10 min. prior to heat treatment. The sample was then heated up to 1000° C. under flowing nitrogen. The heat treatment was performed as follows: 1) heat for 18 min to reach 1000° C., 2) maintain at 1000° C. for 5 min., 3) slowly cool to 20° C. over 200 min., 4) allow to reach room temperature over 50 min.

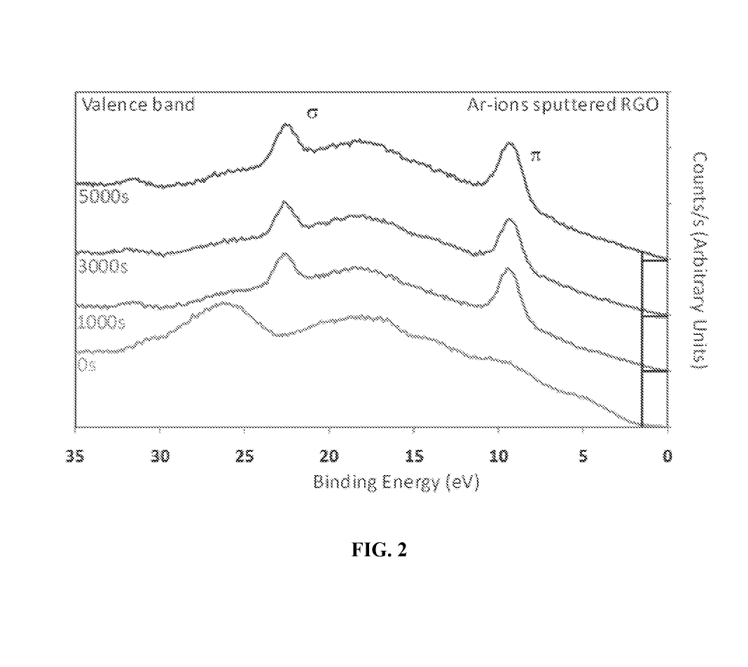

FIG. 2 presents the valance band region of graphene oxide before and after Ar ions sputtering (as a way to study the reduced graphene oxide (RGO)). The characteristic signature of the sigma (σ) and pi (π) bands of the conjugated graphene are clearly seen once the surface has been cleaned of adventitious carbon and adsorbed water from air (sputtering of 1000 s). After that, no considerable change is seen in the spectra (compare the 5000 s and 1000 s spectra) indicating that the bulk structure of the graphene is electronically homogenous. Ar sputtering results in the reduction of the surface and near surface of RGO.

Preparation of Graphene/SrTiO₃ and Graphene/TiO₂ catalysts:

To produce graphene/SrTiO₃, graphene (2 wt. %) prepared in accordance with paragraph [0033] above was mixed with SrTiO₃. Ethanol (100 ml) was then added and the mixture was sonicated in a water bath for 2 hours to get a homogeneous mixture. The mixture was then gently stirred at room temperature for 12 hours to allow for slow evaporation of the solvent. The obtained solid material was then ground to a fine powder. The resulting catalyst was then calcined at 300° C. for 5 hours.

Graphene/SrTiO₃ was also be prepared by dissolving Sr(NO₃)₂ and TiCl₄, Ti((CH₃)₃CO)₄, or Ti(CH₃CH₂O)₄ in water. Graphene (3 wt. %) is then added to the solution and the whole mixture was sonicated for 30 min. SrTiO₃ is precipitated using NH₄OH. The mixture was then washed several times and dried overnight, followed by calcination at 500° C. for 5 hours.

Graphene/CeO₂ was prepared from ceric ammonium nitrate (CeH₈N₈O₁₈) (3.18 g), which was charged into a 100 ml round bottom flask. Water (10 ml) was then added to form a solution. Graphene (3 wt %, 30 mg) was then added to the solution and the whole mixture was sonicated for 30 min. CeO₂ was precipitated using NH₄OH. The mixture was then washed several times and dried overnight, followed by calcination at 500° C. for 5 hours.

### Example 2

### Water Splitting Reactions

The prepared catalyst from Example 1 (20 mg, powder) was charged into a batch reactor. The catalyst was then reduced at 300° C. for one hour. The reactor was purged with nitrogen gas for 30 min. Water (25 ml) was then injected into the reactor. The mixture was stirred under UV-irradiation. Gas samples were collected using a syringe and analysed by using GC-TCD equipped with a Porapak Q column at different time intervals.

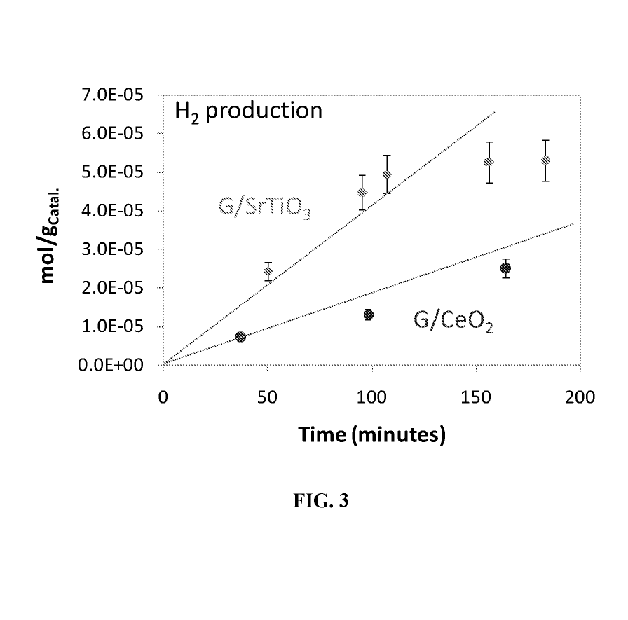

FIG. 3 presents the results of UV-excited experiments using graphene/SrTiO₃ and graphene/CeO₂ catalysts. In the case of graphene/SrTiO₃, hydrogen production appears linear up to about 100 minutes of reaction, after which the production rate slowed down considerably. Considering the surface area of SrTiO₃ used in this work, which is about 3 m²/g, and roughly equates to 2×10¹⁹ atoms of O at the surface, the total hydrogen concentration per g_{Catal}. was found to be 3×10¹⁹ molecules. This indicated that a catalytic reaction was taking place. In the case of graphene/CeO₂, hydrogen production was of a similar rate as that observed for graphene/SrTiO₃. However, in this case there appeared to be continuous increase with time, although the reaction rate was weaker. This was expected because a good part of the valence band of CeO₂ were in the high energy UV region, while the excitation lamp is in the low energy side of UV.

1. A photocatalyst comprising a conductive material having graphene nanostructures attached to the surface of a photoactive metal oxide semiconductor selected from SrTiO₃ or CeO₂, wherein the photoactive metal oxide semiconductor is a microstructure or larger.

2. The photocatalyst of claim 1, wherein the graphene is graphene oxide.

3. The photocatalyst of claim 1, wherein the graphene oxide is reduced graphene oxide.

4. The photocatalyst of claim 1, wherein the photoactive metal oxide semiconductor is SrTiO₃.

5. The photocatalyst of claim 1, wherein the photoactive metal oxide semiconductor is CeO₂.

6. The photocatalyst of claim 1, wherein the photoactive metal oxide semiconductor is a particle.

7. The photocatalyst of claim 1, comprising less than 5, 4, 3, 2, or 1 wt. % of the conductive material.

8. The photocatalyst of claim 1, wherein the nanostructures are nanowires, nanoparticles, nanoclusters, or nanocrystals, or combinations thereof.

9. The photocatalyst of claim 8, wherein the nanoparticle is spherical or substantially spherical in shape.

10. The photocatalyst of claim 1, wherein the conductive material does not cover more than 50, 40, 30, 20, 10, or 5% of the surface area of the photoactive metal oxide semiconductor.

11. The photocatalyst of claim 1, wherein the graphene is attached to the surface of the photoactive metal oxide semiconductor via precipitation of the photoactive metal oxide semiconductor from an aqueous solution comprising the graphene.

12. The photocatalyst of claim 1, wherein the photocatalyst is capable of catalyzing the photocatalytic electrolysis of water.

13. A water splitting system comprising:
a transparent container comprising the photocatalyst of claim 1 and water; and
a light source for irradiating the aqueous solution.

14. A method of converting H₂O to H₂ and O₂ comprising irradiating an aqueous solution comprising the photocatalyst of claim 1 and water with UV irradiation, wherein the H₂O is converted into H₂ and O₂.

15. The method of claim 14, wherein the aqueous solution is prepared by addition of the photocatalyst to water.

16. The method of claim 15, wherein the photocatalyst is heated to between 200° C. and 400° C. prior to addition of the photocatalyst to the water.

17. The method of any claim 1, wherein the aqueous solution comprises between 1 wt. % and 5 wt. % of the photocatalyst.

18. The method of any claim 1, wherein the hydrogen production rate is between 2×10⁻⁷ and 3×10⁻⁷ mol/g_{Catal} min.
